(19) United States
(12) Patent Application Publication
(10) Pub. No.: US 2011/0303343 A1
(43) Pub. Date: Dec. 15, 2011

(54) MICROFLUIDIC BONDING TECHNOLOGY

(75) Inventors: Gene Parunak, Saline, MI (US); Arthur D. Gershowitz, Ann Arbor, MI (US); Syed Zafar Razzacki, Canton, MI (US)

(73) Assignee: ORIGIO, Inc., Charlottesville, VA (US)

(21) Appl. No.: 13/156,554

(22) Filed: Jun. 9, 2011

Related U.S. Application Data
(60) Provisional application No. 61/353,105, filed on Jun. 9, 2010.

(51) Int. Cl. B32B 37/02

(52) U.S. Cl. 156/60

(57) ABSTRACT

The invention is directed to forming a bond between dissimilar polymer surfaces. By providing one substrate that comprises a vinyl acetate polymer, and then by modifying the surface energy of that substrate, that substrate may be advantageously bonded with a second polymer substrate having a surface whose surface energy has been modified. In one example, the first substrate is a rigid substrate, while the second substrate is a flexible membrane that is comprised of a thermoplastic elastomer and a vinyl acetate.

This application claims the benefit of U.S. Provisional Application No. 61/353,105, filed on Jun. 9, 2010, which is incorporated herein in its entirety.

### FIELD OF THE INVENTION

The present invention relates to methods and systems for creating microfluidic devices. More particularly, it relates to substrate bonding technology for such devices.

### BACKGROUND

Silicon and glass, photolithographically etched, were the materials of choice for many early microfluidic devices, but the commercial pressure for economical fabrication techniques has led to the increased use of polymers in microdevices. Polymeric microfluidic devices are typically formed of injection molded, stamped, or extruded substrates with networks of micro-channels formed in one or more of the aces of the substrate. This arrangement leaves one wall of the channel temporarily open during assembly until it is closed by a laminate or second substrate applied to the face. This multi-step process results in a structure of micro-channels of arbitrary complexity through which fluids may be pumped under the control of a propulsion mechanism. The micro-channels typically have at least one dimension which is on the order of less than one millimeter.

The process of joining multiple polymer microfluidic layers together in a durable and water-tight fashion usually involves adhesive or heat-sealing bonding methods. Each of these bonding techniques has certain drawbacks which, although acceptable in many bonding scenarios, make them particularly ill-suited for microscale fluidic device bonding.

In the case of adhesive bonding, while many methods for application and curing exist, in most cases, the cured adhesive layer is at least partially exposed within the channel network. This is generally untenable since many adhesives are not chemically compatible with the assay or process being performed. In the micro-channels. Additionally, the adhesive chosen may have optical properties differing from those of the substrate.

In the case of thermal bonding, deformation is inescapable, being a necessary byproduct of the requisite heat and pressure. For macroscopic projects, this deformation is usually acceptable, but on the microscale, the required deformation zone generally encompasses the entire depth of the channel network and renders the channel geometry variable from part to part if it does not obliterate it entirely.

In both thermal and, to a lesser extent, adhesive bonding scenarios, attempting to join dissimilar materials poses a challenge. Adhesives appropriate for one material may not be appropriate for the other, and thermal bonding only works well with highly similar materials, as molecular tangling is unlikely with dissimilar materials. For this reason, it is not generally possible to join materials with differing softening and/or melting temperatures (such as plastics and elastomers) by means of thermal bonding.

Some successes have been realized in the art by the discovery of PDMS (polydimethylsiloxane) to PDMS and PDMS to glass bonding through the use of plasma or corona discharge. These are very successful, and have been used in the creation of many microfluidic devices in the research space. However, PDMS is more appropriate for research use than for mass production of microfluidic devices, and injection molded plastics with micro-features, as noted, are notoriously difficult to bond consistently.

In the field of microfluidic human embryo culture the previously described limitations of adhesives and thermal bonding are in full force. Embryos are supremely sensitive to toxicity in their culture environment, and the microfluidic pulses of fluid over the embryos must be small (on the order of 8 nl) and consistent from system to system. This pulse size necessitates the creation of channels with consistent volume and minimal voids. Additionally, the chosen peristaltic pumping mechanism of some systems requires one of the substrates of the microdevice to be elastomeric in nature.

### SUMMARY OF THE INVENTION

In general the invention provides a system and method for bonding dissimilar materials in order to form an integrated microfluidic device for cell culture for human in-vitro fertilization. The invention is also applicable to microfluidic devices for diagnostics and for other purposes. The invention is further applicable to non-fluidic macro-scale products wherein it is desirable to avoid the use of traditional adhesives or thermal bonding methods.

In one embodiment, the invention provides a method for bonding two or more substrates comprising: forming at least one substrate from a polymer containing vinyl acetate; modifying the surface energy of the substrates; pressing the substrates together; and allowing the bond to cure.

In a further embodiment, the substrates are used in microfluidics. In yet another embodiment, the substrates have dissimilar material properties.

In some embodiments, the polymer is from about 3% by wt to about 50% by wt vinyl acetate. In some embodiments, the polymer is from about 5% by wt to about 20% by wt vinyl acetate. In some embodiments, the polymer is 9% by wt vinyl acetate.

In some embodiments, at east one of the substrates is an elastomer. In some embodiments, at least one of the substrates is a blend of ethylene-vinyl-acetate and thermoplastic-elastomer. In some embodiments, the blend is 9% by wt vinyl acetate.

In some embodiments, the substrates are plasma treated.

In some embodiments, at least one of the substrates is polystyrene. In some embodiments, at least one of the substrates is mylar.

In some embodiments, the resulting bond is optically clear. In some embodiments, the resulting bond is opaque. In some embodiments, the resulting bond is water resistant.

In one embodiment, the invention provides a method for bonding two or more substrates having dissimilar material properties comprising: forming at least one substrate from a polymer containing vinyl acetate; modifying the surface energy of the substrates; pressing the substrates together; and allowing the bond to cure.

In one embodiment, the invention provides a method for bonding a substrate containing vinyl acetate with a substrate having dissimilar material properties,

In a further embodiment, the vinyl acetate is blended with a thermoplastic-elastomer.

In some embodiments, the invention further provides utilizing the bonded substrates for cell culture. In some embodiments, the cell culture is for human in-vitro fertilization. In some embodiments, the substrates are biocompatible.

In one embodiment, the invention provides a device produced by a method for bonding two or more substrates comprising: forming at least one substrate from a polymer containing vinyl acetate; modifying the surface energy of the substrates; pressing the substrates together; and allowing the bond to cure.

In one embodiment, the invention provides a method of bonding a substrate containing vinyl acetate to a polystyrene substrate. In some embodiments, the vinyl acetate is blended with a thermoplastic-elastomer.

The substrate materials to be bonded include, but are not limited to, those in the following families: polystyrenes, polyurethanes, polypropylenes, thermoplastic elastomers, thermoplastic urethanes, PET, ABS, Polyester, and Polycarbonate.

While surface energy modification techniques are well known in the various industries to increase adhesion of glues and inks, the present discovery involves the use of surface energy modification to join dissimilar materials without the use of additional adhesives. Similar results have been achieved by others using PDMS (poly-dimethyl-siloxane) bonded to PDMS, but these materials are inappropriate for commercial microfluidic systems and both parts being bonded are made from the same material.

It has been found that by combining vinyl acetate in various concentrations with other base polymers in an extrusion or molded part, and by surface treating the vinyl-acetate laden polymer as well as the other piece to be bonded, that excellent, water resistant adhesion can be achieved without any additional adhesives.

In a preferred embodiment, an extrusion is made of an ethylene-vinyl-acetate and thermoplastic elastomer blend. This extruded membrane is then plasma treated on a conveyor system and subsequently adhered to a polystyrene microfluidic cartridge body (also plasma treated) by rolling application. The assembly is placed at an elevated temperature overnight (or held at room temperature for a few days) to increase the bond strength.

In another preferred embodiment, an extrusion of an ethylene-vinyl-acetate and thermoplastic elastomer blend is adhered to a mylar film to achieve barrier properties not present in the elastomer film itself. This arrangement can also be used to create clear mylar “floors” in an assembly with near-zero-dead-volume bonds. A “near-zero-dead-volume” bond is defined as a bond with minimal voids present at the interface of the bond and an enclosed channel. Adhesive bonding techniques generally require a small void around the channel perimeter to prevent adhesive intrusion into the channel proper. Adhesive-less, non-deforming techniques as described herein neither create voids nor do they introduce material into the channel network.

In yet another preferred embodiment, a micro-patterned ethylene-vinyl-acetate and polymer blend is adhered to a hard polymer substrate using the afore-mentioned technique.

### BRIEF DESCRIPTION OF THE DRAWINGS

FIG. 1 depicts an exploded view of a cartridge used during in vitro fertilization systems.

FIG. 2 depicts a top view of the cartridge.

FIG. 3 depicts a bottom view of the cartridge.

FIG. 4 depicts another exploded view of the cartridge.

FIG. 5 depicts a cross sectional view of the cartridge well bottom.

### DETAILED DESCRIPTION

### Definitions

As used herein, “biocompatible” means compatible with biological tissue and further passes a mouse embryo assay.

As used herein, “optically clear” means the bond and/or the substrate is able to be seen through with reasonable visual clarity.

As used herein, “plasma treated” means a process for the treatment of a surface which results in modification of the surface energy. Examples of plasma treatments include but are not limited to: Corona discharge; Atmospheric Plasma; Vacuum Plasma; and Flame Treatment.

As used herein, “to cure” means to strengthen or accelerate the strengthening of the bond initially formed.

Broadly speaking, the current invention is directed to a method for bonding two substrates together. One or both of the substrates may be substantially rigid and relatively unbending. Additionally, one or both of the substrates may be flexible. Each of the substrates is formed from a polymer material, with each of the polymer compositions being different. Still further, one of the substrates may be rigid, while the second substrate is flexible. In each example, the respective s faces of the first and second substrates that will be bonded together are each treated to modify the surface energy of the respective surfaces. In one example, surfaces are subjected to a plasma treatment process. The treated surfaces of the two substrates are then pressed together and allowed to cure with the bond forming there between as a result of the surface energy being modified.

The amount and degree of surface energy modification will depend entirely on the polymer composition of a given substrate. In other words, some polymers require a much higher plasma treatment in order to make the surface polymer reactive enough to form a bond with a second surface. Other polymers require less plasma treatment. In one example, at least one of the substrates will include an amount of vinyl acetate, for instance ethylene vinyl acetate. The vinyl acetate may comprise about 3% by weight to about 50% by weight of the substrate polymer, alternatively about 5% by weight to about 20% by weight of the polymer, or further alternatively about 9% by weight of the polymer. Other vinyl acetate blends that may be used include those compounded with the following families of materials: Styrenic block copolymer; Acrylic; and Butyl.

Other families of polymers that are believed to be especially favorable when modifying surface energy include the following: polystyrene, polyester, polyproplylene, and thermoplastic urethane.

The amount of surface energy modification required to achieve an acceptable bond will vary depending on the polymer being treated. For instance, different polymers in a substrate and/or membrane may require more or less treatment before being able to achieve an acceptable bond. Likewise, different equipment and different external processing conditions will require operation under unique equipment processing parameters.

In a preferred embodiment of a microfluidic device, three substrates are joined together by means of their material properties and the application of a gas plasma. The three materials are: a microfluidic cartridge with surface channels (30 microns deep by 300 microns wide) and vias (1-3 mm in diameter) injection molded from polystyrene (Resirene HF-555), a 1.25″ square elastomeric membrane consisting of a 0.010″ thick extruded blend of ethylene-vinyl-acetate and thermoplastic elastomer (Elvax 3185 and GLS CL2250 in a ratio of 1:2.67 by weight), and a 0.0005″ polyester film (McMaster part #8567K104).

In each of two bonding steps, the respective surfaces of the substrates to be bonded are passed at 25 ft/min on a conveyor, such that the surfaces to be bonded pass a few millimeters under the 1 inch wide spreader nozzle of a Tri Star Technologies PT-2000P Duradyne plasma treatment unit. The plasma treatment unit is set up with approximately 0.05 SCFH (Standard Cubic Feet per Hour) Oxygen flow and approximately 20 SCFH Argon flow.

After the first treatment, the membrane substrate is hand rolled onto the cartridge body substrate using a 1 inch diameter rubber roller. After subsequent operations including the punching of holes in the membrane, the mylar substrate and membrane are plasma treated, and the mylar is rolled on to the membrane/cartridge, completing the microfluidic portion of the device.

After bonding, the composite devices are place in a 40° C. oven overnight to accelerate the bond strength maturation. Testing indicates that bond strength matures more rapidly under heat than at room temperature. However, the bond may also adequately cure at room temperature.

In alternative examples, the vinyl acetate content of a membrane substrate may vary between about 3% by weight and about 75% by weight, with the concentration of vinyl acetate ideally varying between about 5% by weight and about 20% by weight of the entire membrane substrate.

The thickness of a membrane substrate is ideally 10 mils, but can vary widely depending on the polymer/polymers used to form the membrane and the ultimate purpose of the composite device.

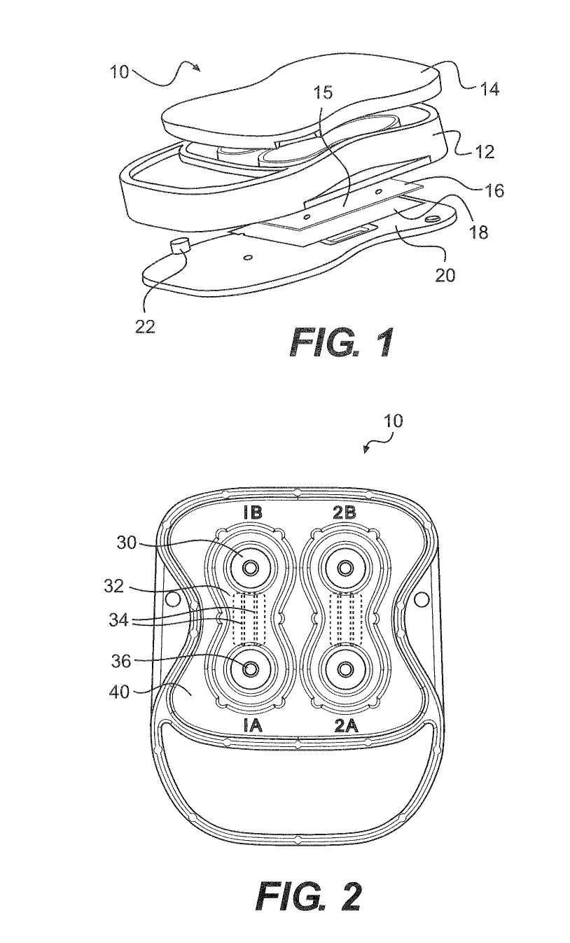

In one example, an embryo culture system includes a plastic consumable cartridge shown in FIGS. 1-5. The cartridge 10 is a single-use disposable component that attaches to a pump and is configured to contain wells and channels to provide a dynamic, microfluidic culture environment up to the time of transfer. The system is intended to be used for culturing human embryos for in vitro fertilization.

The cartridge 10 is constructed primarily of polystyrene, an optically transparent, biocompatible material that has a history of safe use in many medical device applications. All materials except for the magnet are clear. The UV adhesive is applied to several locations on the baseplate 20, and secures the baseplate to the body 12.

As shown in FIG. 2, the cartridge 10 contains two microfluidic channel circuits 34, each having two identical funnel-shaped wells 30 that are open at the top. All wells 30 are to be loaded with media of the IVF facility's choice and one well in each circuit is also to be loaded with up to five embryos. The wells 30 within a circuit are connected through two channels 34 that enter and exit through the bottom of each well. The channels 34 connecting the wells 30 are sufficiently small (30 μm in height) so as to exclude embryos (which are approximately 130 μm or greater in diameter) from entering the channels. The two wells 30 in a circuit are contained within a taller reservoir 32 that will contain mineral oil to prevent media evaporation. Both circuits are located within a larger spill catch basin 40 whose purpose is to contain spills.

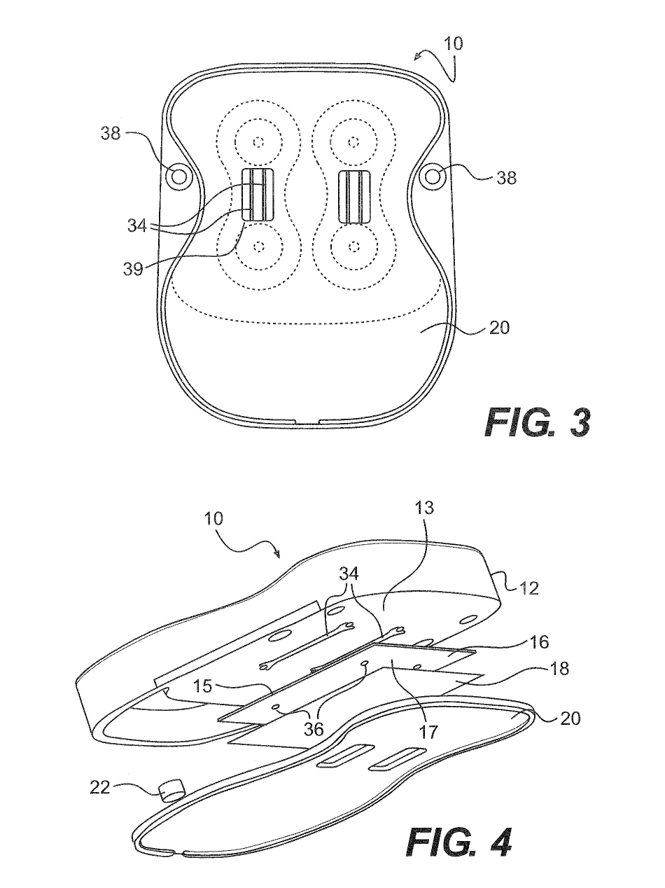

As shown in FIG. 3, openings 39 (windows) in the baseplate 20 provide access to the membrane 16 sealing the bottom of the channels 34. The membrane 16 is a blend of a thermoplastic elastomer (TPE) with ethylene vinyl acetate (EVA). When the membrane 16 is deflected into the channels 34 by the pins of a pump, the sequential occlusions generate peristaltic pumping, and a flow of media between the wells 30 in a circuit. The locating holes 38 align with posts on a pump, serving to position the cartridge 10 correctly on the pump.

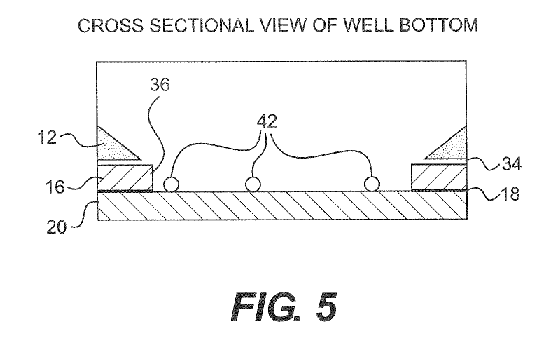

As shown in FIG. 4, the microfluidic channels 34 can be seen where they are molded into the base of the body 12 of the cartridge 10. An elastomeric membrane 16 formed from TPE (thermoplastic elastomer) is applied to the bottom of the cartridge body 12, sealing the open bottom of wells 30 and channels 34. Subsequently, holes 36 are punched through the membrane 16 at the base of each well 30 (see FIG. 5). A thin sheet 18 of polyester is then adhered to the exposed bottom of the membrane 16 to seal off the holes 36 and to protect the membrane from contact with any contaminants (e.g. mineral oil) that may be on the pump. A baseplate 20, molded from polystyrene, is affixed to the bottom of this assembly. It supports and protects the membrane 16, and holds a magnet 22. The magnet 22 is sensed by the pump, indicating that a cartridge 10 is present.

The channels 34 are pumped through a peristaltic process involving plungers which depress the membrane 16 into the microchannels. As such, the bond is sufficient to withstand this repeated abuse, and its ability to withstand such pressures is enhanced if the orientation of the membrane 16 (extrusion direction) is parallel to the microfluidic channels 34 being pumped,

As shown in FIG. 5, the hole 36 in the TPE membrane 16 is approximately equivalent in diameter to the hole through the base of the well in the cartridge body (diameter 1.5 mm). It exposes the section of the polyester sheet 18 upon which the embryos 42 rest. This hole 36 drops the embryos 42 below the level of the microfluidic channels 34, sheltering them from the direct force of the flow.

The membrane 16 has a top surface 15 that is treated to modify the surface energy of that top surface. At the same time, the bottom surface 13 of the body 12 is likewise treated to modify its surface energy. The membrane 16 and the body 14 are sealed together by pressing the surface energy modified sides 15 and 13 of the respective membrane 16 and body 12 together. Then, in a subsequent action, the bottom surface 17 of the membrane 16 is then treated to modify its surface energy. The polyester sheet 18 has its surface energy modified so that then the membrane 16 and polyester 18 are similarly bonded together by pressing them against each other.

### EXAMPLE 1

### Bond Strengths of Membrane and Cartridge Candidate Materials

The objective was to assess the quality of bond formed between various cartridge and membrane materials subsequent to treatment with plasma in argon and oxygen.

A range of cartridge and membrane materials were in-house and available for evaluation. A review of the membrane material data sheets indicated which of the cartridge materials they would best adhere to. Those pairings were selected for this study. In addition PET cartridges were assessed for each membrane, as PET was not reviewed in the data sheets and is believed to be a good candidate cartridge material.

Samples of each membrane/cartridge material pair were plasma treated using nominal conditions for EVA/2250 blended membrane (9% vinyl acetate) on a Polystyrene cartridge. Excepting PET cartridges, all combinations were also plasma treated with longer and shorter exposure times (i.e. faster and slower belt speeds). Cartridges were then placed in a 40° C. oven for at least 12 hours. After cartridges were removed and cooled to room temperature the membranes were manually peeled off, and the quality of the bond was subjectively assessed.

### Materials and Equipment:

1. Cartridges as Follows:

| Material (Resin/Supplier/Supplier ID) | Part No. |
|---|---|
| Polypropyiene/LyondellBasill/Profax PD702 natural | C00001/1 |
| ABS/Sabic/Cycolac MG94MD | C00001/1 |
| PET/Eastman/Eastar MN005 | C00001/1 |
| Polystyrene/Resirene/HF-555 | C00003/2 |
| Polycarbonate/Lexan HPSI-1129 | None |

2. Membrane as Follows:

Material (Supplier/Supplier ID/thickness)

GLS/CL2250/8 mil
GLS/CL2242/8 mil
Kraton/G2705Z/8 mil
RTP/6035-35A/8 mil
GLS/G2711-1000-00/8 mil
GLS/OM1040X-1/8 mil
Custom Blend of Dupont 33% Elvax 3185 and GLS 2250
resulting in a blend that is 6% vinyl acetate/10 mil

Membrane materials were cut to a width sufficient to cover half the width of the cartridge. Membranes were peeled from backing. Cartridge and membrane were placed onto a plasma treatment fixture and the fixture was placed on a belt running at the designated speed. Membranes and cartridges were passed one time under the plasma nozzle with a gap of 2.0-2.5 mm. Plasma settings: 20 SCFH Argon, 0.5 SCFH O2, 85% intensity with minimized current. The membranes were laminated to the cartridges and the cartridges were placed into a 40° C. oven for at least 12 hours,

Test Procedure:
1. Assemble three of each of the following combinations of membrane material and cartridge material per sample preparation.
2. Remove cartridges from oven and let cool to room temperature.
3. Peel membrane off cartridge and note strength of bond on a scale of 1 to 10:
   1=Minimum bond strength. Weakly adhered.
   5=Strong bond. Membrane can be pulled off of cartridge without leaving residue and without tearing.
   6=Bond is just strong enough that membrane tears when being removed from cartridge. No residue is left behind.
   10=Strongest bond. Can't peel a significant amount of material without ripping it.

### Results:

| | | Cartridge Mtl. | | | | |
|---|---|---|---|---|---|---|
| | | | ABS (acrylonitrile | | | |
| | Belt speed* | Polypropylene | butadiene styrene) | Polycarbonate | Polystyrene | PET |
| CL2250 | 12 | 4, 4, 4 | | | | |
| | 24 | 5, 5, 5 | | | | |
| | 42 | 3, 5, 5 | | | | |
| | 24 | | | | | 5, 5, 5 |
| CL2242 | 12 | 3, 4, 4 | | | | |
| | 24 | 4, 4, 4 | | | | |
| | 42 | 3, 3, 4 | | | | |
| | 24 | | | | | 4, 4, 4 |
| G2705G | 12 | 3, 3, 3 | | | | |
| | 24 | 4, 4, 4 | | | | |
| | 42 | 3, 4, 4 | | | | |
| | 24 | | | | | 3, 3, 4 |
| RTP6035 | 12 | 1, 1, 1 | | | | |
| | 24 | 3, 3, 3 | | | | |
| | 42 | 1, 1, 1 | | | | |
| | 24 | | | | | 1, 1, 1 |
| | 12 | | | | 1, 1, 1 | |
| | 24 | | | | 1, 1, 1 | |
| | 42 | | | | 1, 1, 2 | |
| G2711 | 12 | 1, 1, 1 | | | | |
| | 24 | 3, 3, 3 | | | | |
| | 42 | 1, 1, 1 | | | | |
| | 24 | | | | | 1, 1, 1 |
| OM1040 | 12 | | 1, 1, 1 | | | |
| | 24 | | 1, 0, 1 | | | |
| | 42 | | 1, 1, 1 | | | |
| | 24 | | | | | 1, 1, 1 |
| | 12 | | | 1, 1, 1 | | |
| | 24 | | | 1, 1, 1 | | |
| | 42 | | | 1, 1, 1 | | |
| 6% blend | 12 | 5, 5, 5 | | | | |
| | 24 | 5, 5, 10 | | | | |
| | 42 | 10, 10, 10 | | | | |
| | 24 | | | | | 10, 10, 10 |
| | 12 | | | | 5, 5, 5 | |
| | 24 | | | | 10, 10, 10 | |
| | 42 | | | | 5, 5, 4 | |

The bond strength formed between the 6% blend and polypropylene, polystyrene and PET was much stronger than that formed by any other combination of materials. These are the only combinations tested that are believed to be strong enough that they may withstand pumping of aqueous-fluid containing channels.

### EXAMPLE 2

### Blended Membrane Bonding Assessments

The objective was to assess the bond strength of membranes consisting of different ratios of EMS 2250 and Elvax 3185. Also to assess the effect of membrane orientation bond strength for a selection of these membranes (i.e. positioning the backing side of the membrane towards or away from the cartridge surface).

A previous study confirmed that bond strength of the 6% vinyl acetate blend of 2250 and 3185 was dependent on membrane orientation, being much stronger when the backing side of the membrane is towards the cartridge (i.e. In the bond area).

All membranes were bonded with the backing side of the membrane towards the cartridge. In addition the 6% 10 mil membrane and the 9% 10 mil membrane were bonded with the non-backing side of the membrane in the bond area. All bonds were assessed subjectively by peeling them off the cartridge and assessing for the force required and presence/absence of membrane residue on the cartridge.

### Materials and Equipment

### Polystyrene Cartridges

All membranes in the table below are custom blends of Dupon Elvax 3185 and GLS 2250, in ratios producing the indicated vinyl acetate content.

Membrane description

```
  9% vinyl acetate/10 mil thick
  6% vinyl acetate/10 mil thick
  6% vinyl acetate/8 mil thick
  6% vinyl acetate/6 mil thick
  6% vinyl acetate/4 mil thick
4.5% vinyl acetate/8 mil thick
4.5% vinyl acetate/6 mil thick
4.5% vinyl acetate/4 mil thick
  3% vinyl acetate/10 mil thick
```

Membranes were cut into squares roughly 1¼″ on a side. The backing was removed from the membrane and the cartridge and membrane without backing were placed on the plasma treat fixture oriented as described in the procedure. The loaded fixture was then placed on a 25 foot per minute belt and passed under the plasma nozzle with a gap of 2.0-2.5 mm. Plasma settings 20 SCFH Argon, 0,5 SCFH O2, 85% intensity with a current of 0.7. The nozzle position was adjusted to minimize overlap when the fixture is reversed for the second pass. The membrane was then placed on a roller and laminated to cartridge at room temp. The cartridge was then placed in a 40° C. oven overnight.

### Test Procedure

1. Using the method described above fabricate three cartridges each with the membranes and orientations shown below.
2. After removal from oven peel membranes by hand and assess bond quality according to the following scale:
   1=Minimum bond strength.
   5=Maximum bond strength for which the bond is weaker than the membrane material.
   6=Weakest bond strength for which bond is stronger than material. This is evidenced either by tearing of the membrane, or by residue remaining on the cartridge after membrane is removed.
   10=Strongest bond. Can't peel any material without ripping it and/or leaving residue. Membrane must be scraped off to be removed.

### Results

| | | Backing side: | | | | |
|---|---|---|---|---|---|---|
| | Membrane | | Opposite | | | |
| Item | description | Towards bond | bond | Assessments | | |
| 1 | 9%/10 mil thick | X | | 10 | 10 | 10 |
| 2 | 9%/10 mil thick | | X | 5 | 4 | 4 |
| 3 | 6%/10 mil thick | X | | 9 | 9.5 | 9 |
| 4 | 6%/10 mil thick | | X | 5 | 5 | 5 |
| 5 | 6%/8 mil thick | X | | 6 | 5 | 6 |
| 6 | 6%/6 mil thick | X | | 5 | 7 | 7 |
| 7 | 6%/4 mil thick | X | | 8 | 7 | 7 |
| 8 | 4.5%/8 mil thick | X | | 7 | 7 | 6 |
| 9 | 4.5%/6 mil thick | X | | 7 | 7 | 7 |
| 10 | 4.5%/4 mil thick | X | | 8 | 8 | 9 |
| 11 | 3%/10 mil thick | X | | 6 | 6 | 6 |

Reducing the vinyl acetate content from 9% to 6% and lower reduces bond strength. The 9% membrane forms the strongest bond, and is the only one that leaves behind an almost uniform layer of residue when peeled off the cartridge. The 6% 10 mil membrane forms a bond almost as strong as the 9%. The difference between the two is more qualitative: the 6% 10 mil does not leave behind as uniform a layer of residue. Cartridges fabricated with 6% 10 mil membrane have been pumped without delaminating, so this membrane is a viable candidate.

Bond strength formed with the 4.5% membrane may be adequate to prevent a pumped cartridge from delaminating during use. Bond strengths of the 4.5% and 6% membranes at a given thickness were comparable. Embodiments having vinyl acetate content below 9%, membranes having 6% and 4,5% are worth consideration. The bonds formed by the 3% vinyl acetate content membranes were slightly weaker than the others.

This study reconfirms that membrane orientation (backing side towards or away from bond) significantly affects bond quality. Strongest bonds are formed when the membrane side that was extruded onto the backing is placed against the cartridge. Possible explanations include contaminants on the exposed surface or differing surface chemistries between the surfaces.

There is not a strong trend regarding bond strength as a function of membrane thickness. There is, with the 4.5% membrane, a slight trend towards stronger bonds with thinner material. However, this trend is called into doubt when considering that the strongest of the 6% bonds was achieved with the thickest material. It may be that other variables are at play, such as variation in the extrusion process. For example the 10 mil 6% was extruded at a different time from the thinner 6% membranes.

### EXAMPLE 3

### Study of Pressure Used to Bond Example Substrates

Tests were made to identify a range of pressures necessary to fix an EVA/TPE blend to a microfluidic cartridge having channels with a roughly trapezoidal channel cross section of up to 550 um across and a channel depth of up to 35 microns deep. This study provides a range of allowable application pressures to ensure that adhesion successfully occurs without inadvertently obstructing a channel.

### Equipment Used

### Polystyrene Microfluidic IVF Cartridge

9% EVA/2250 Blend
3% EVA/2250 Blend
Force Gauge—A.W. Sperry SFG-5000 SN K84259 with flat, circular tip Sheet of “applicator” elastomer stock (nominally 60) shore A durometer)
Hole Punches
Measurement Calipers

### Methods and Data

### Phase 1—Applicator Disk Thickness

A 0.18 inch diameter “applicator” disk was punched from stock and calipers were used to measure it's thickness (0.06 inches).

### Phase 2—EVA/2250 Blend Thickness

Approximately 1 inch square samples of EVA/2250 blend (with varying Vinyl Acetate concentrations) were cut and their thicknesses were measured using calipers as follows:

| Blend Sample | VA % | Thickness (in) |
|---|---|---|
| A | 3% | 0.08 |
| B | 9% | 0.07 |
| C | 9% | 0.010 |

### Phase 3—Minimum/Maximum Application Pressure

For each test case the appropriate EVA/2250 blend sample was placed lightly underneath the cartridge and the pair were placed over a vertically positioned force gauge with the applicator disk resting on the flat tip of the force gauge. Alignment was made such that the center of the applicator disk was at or near the centerline of an open-faced microfluidic channel. Using the force gauge's peak hold setting, the cartridge was pressed down on top of the three gauge.

Two readings were taken for each test case. For the first, pressure was released and the peak force noted as soon as the EVA/2250 blend visually “wetted” the polystyrene cartridge under at least 50% of the applicator disk area. The 50% threshold was chosen to take into account edge effects which are not present in a roll application scenario. “Wetting” of the cartridge represents the removal of substantially all of the air in between the two substrates and is the point at which bonding can be reasonably expected to occur if the parts are properly treated before contact.

For the second reading, pressure was applied and increased until a portion of the membrane occluded the channel near the center of the applicator disk. The peak force was recorded for this event, representing a pressure just above the actual maximum tolerated by the application process. The summary results are presented in the figure below.

| | | Minimum | Occlusion |
|---|---|---|---|
| | Blend | Application | Pressure |
| Test # | Sample | Pressure (psi) | (psi) |
| 1 | A | 8.10 | 41.84 |
| 2 | B | 9.35 | 49.11 |
| 3 | C | 10.70 | 45.43 |
| Average | 9.38 | | |
| Minimum | | | |
| Application | | | |
| Pressure (psi) | | | |
| Average | 45.46 | | |
| Occlusion | | | |
| Pressure (psi) | | | |

### Analysis

Even with the small number of samples tested, there is no significant trend observed regarding the effect of thickness or vinyl acetate content on the minimum or maximum application pressures.

On average, the bonding process requires a minimum application pressure somewhat over 9 psi and generally cannot tolerate a bonding pressure of more than 45 psi. The tolerance about these pressures is unknown.

### Other Embodiments

While we have described a number of embodiments of this invention, it is apparent that our basic examples may be altered to provide other embodiments which utilize the compounds and methods of this invention. Therefore, it will be appreciated that the scope of this invention is to be defined by the appended claims rather than by the specific embodiments that have been represented by way of example above.

What is claimed is:

1. A method for bonding together the adjacent surfaces of two polymer substrates comprising the steps of:
providing a first polymer substrate comprising vinyl acetate, wherein the first polymer substrate comprises a first surface;
providing a second polymer substrate comprising a second surface;
modifying the surface energy of the first and second surfaces; and
pressing together the first and second surfaces to bond them together.

2. The method of claim 1, wherein the first polymer substrate is a flexible membrane.

3. The method of claim 1, wherein the first and second substrates have dissimilar material properties.

4. The method of claim 1, wherein the first polymer substrate is from about 3% by o about 50% by wt vinyl acetate.

5. The method of claim 4, wherein the first polymer substrate is from about 5% by wt to about 20% by wt vinyl acetate.

6. The method of claim 4, wherein the first polymer substrate is 9% by wt vinyl acetate.

7. The method of claim 1, wherein at least one of the substrates is an elastomer.

8. The method of claim 1, wherein the first substrate is a blend of ethylene-vinyl-acetate and thermoplastic-elastomer.

9. The method of claim 8, wherein the blend is 9% by wt vinyl acetate.

10. The method of claim 1, wherein the substrates are plasma treated.

11. The method of claim 1, wherein the second substrate is comprised of polystyrene.

12. The method of claim 1, wherein the second substrate is comprised of polyester.

13. The method of claim 1, wherein the resulting bond is optically dear.

14. The method of claim 1, wherein the resulting bond is opaque.

15. The method of claim 1, wherein the resulting bond is water resistant.

16. The method of claim 1, further comprising utilizing the bonded substrates for cell culture.

17. The method of claim 16, wherein the cell culture is for human in-vitro fertilization.

18. The method of claim 17, wherein the substrates are biocompatible.
